(19) United States
(12) Patent Application Publication
(10) Pub. No.: US 2020/0226901 A1
(43) Pub. Date: Jul. 16, 2020

(54) Wirelessly Activated Monitored Safety Temperature Sensing Alarm

(71) Applicants: Claudia Estera Tavoc, Reading, PA (US); Jason Lee Thompson, Cumberland, MD (US); Jeremiah Jesse Tavoc, Reading, PA (US)

(72) Inventors: Claudia Estera Tavoc, Reading, PA (US); Jason Lee Thompson, Cumberland, MD (US); Jeremiah Jesse Tavoc, Reading, PA (US)

(21) Appl. No.: 16/550,207

(22) Filed: Aug. 24, 2019

Related U.S. Application Data
(60) Provisional application No. 62/791,098, filed on Jan. 11, 2019.

(51) Int. Cl. G08B 17/06; G08B 3/10; G08B 5/22; G08B 27/00

(52) U.S. Cl. CPC G08B 17/06; G08B 27/00; G08B 5/223; G08B 3/1016

(57) ABSTRACT

This Wireless Safety Temperature Sensing Alarm is a thermally actuated alarm designed to send a wireless signal to a remote base which will turn on a buzzer, a visual light signal or an emergency alert system to alert anyone around that a child/person/pet/plant has been left in a confined environment that is experiencing extreme temperatures, whether hot or cold. It can also simply alert someone that a certain device or environment has reached the user defined set point temperature. It consists of 2 units: a base and a remote. The base is easily installed on any kind of carrier or as a standalone fixture, and it is designed to sense the temperature of the environment that the child/person/pet/plant is in and it can trigger a wireless signal on the remote to turn on the buzzer/alarm, and a flashing light for people who are hearing impaired or send an RF signal emergency alert. It's designed with a 10 minute turn-on delay to prevent false alarms upon startup. It also has a low-battery alert as an add-on safety precaution. The remote can be easily carried on or as a standalone device, or is easily installed on the exterior of the confined environment which the child/person/pet/plant is in. This makes it possible for anyone who is nearby to hear/see the alarm and take action. Many lives of children, beloved people, pets, and plants could be saved (and financial loss or wasted time could be prevented) using this easy to install invention. A future development of the product will be able to alert an emergency system in case that human lives are in danger of extreme temperatures.

### FIELD OF THE INVENTION

Electric actuation of an alarm using a thermally-operated switch to wirelessly monitor and turn on an external remote buzzer or an emergency alarm system.

### BACKGROUND

According to the National Safety Council, at least 37 children each year die in the U.S alone from pediatric vehicular heatstroke (PVH). One child is too many, and 37 is a worldwide problem. These are 37 children that suffer for hours, accidently left inside these confined places. There are also beloved pets that are many times forgotten. This can be preventable by a simple to install alarm that senses if the temperature is too high or too low and will alert anybody around that something is wrong. Therefore, there is a great need for this invention so we can stop these worldwide problems. This invention solves many problems, such as: children being forgotten in confined places where the temperature can change extremely, disabled persons that cannot react on their own if the environment changes to be unsafe, pets that are left in confined places where the environment can change drastically, plants that cannot withstand extreme temperatures, or in any situation or application that needs to be thermally monitored and requires a remote/wireless visual or sound alert notification of the temperature change.

Furthermore, this invention can be adapted for many different purposes in many other industries. The food industry could benefit in several ways. Imagine boiling water. Drop one of our base units into the water and put the remote into your pocket. The remote vibrates when the water starts to boil. Or the delivery truck where the temp cannot go above 40 degrees. Drop one of our bases in the back of the truck and put the remote in the cab.

### BRIEF SUMMARY OF THE INVENTION

The present invention is a wireless thermally actuated alarm, designed to alert anyone around (or an emergency system in the near future) that the environmental temperature exceeds the preset limit. This can also mean that a child, person, pet or a living thing has been left in a confined space and is experiencing extreme temperatures, whether hot or cold.

The invention consists of two units, a base and a remote, both powered by 9 volt batteries. Also, both the base and the remote have a low battery indicator for added safety.

The base is designed to be easily installed on the baby, child or pet carrier or as a standalone device. For small children is best utilized as a permanent fixture on a child carrier, using the child's carrier belt as an “on/off” device. It is designed to sense the temperature of confined space and warn others if the temperature rises above a certain point or if the temperature drops below a certain point. Furthermore, to help ensure no false alarms are triggered, there is a delayed time before the unit turns on to allow for initial environment to get to the right levels. There is also a low-battery indicator to prevent loss of power to the device.

The remote is designed to be installed on the outside of the confined space. When activated by the base wirelessly, the external remote sounds a loud alarm/flashes a red light to alert anybody near that there is a dangerous situation present.

### BRIEF DESCRIPTION OF THE DRAWINGS

FIG. 1 A: Base transmitter schematic made up of temperature sensing (101) which sends data to the processing unit (102), which sends data to the RF transmitter (103).

FIG. 1 B: Base device with adjustable temperature sensing, low voltage sense, 10 min delay, RF transmitter, and on/off switch (which for a carrier can be adaptable to a safety belt).

FIG. 2 A: Remote receiver schematic with RF receiver (201), processing unit (202), and alarm unit (203).

FIG. 2 B: Remote device with low voltage sense, audible/visual alarm, RF Receiver, and on/off switch.

FIG. 3: The base device (transmitter) FIG. 1 is sensing the temperature, processing the data, and sends it to the remote device (receiver) FIG. 2 which receives data, processes it, and sounds the alarm.

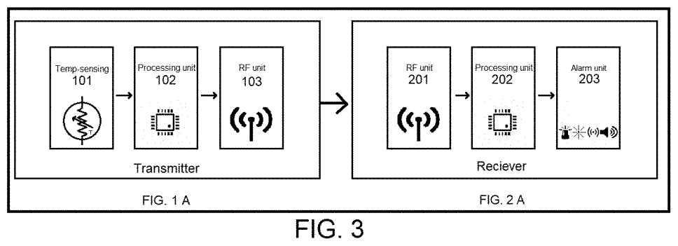

### DETAILED DESCRIPTION OF THE INVENTION

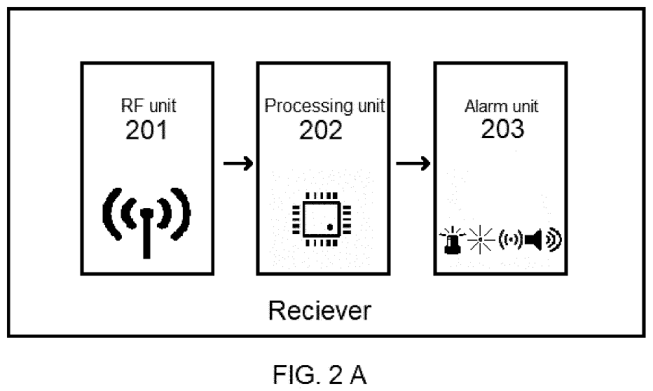

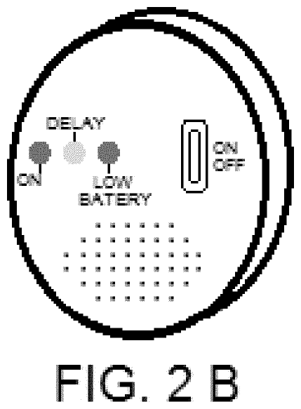

This Wirelessly Activated Safety Temperature Sensing Alarm is a device that senses if the environmental temperature changes 101 from the ones already preset by the user, and processes it through the processing unit 102, and depending on the input, sends an RF signal through the RF transmitter 103 to a device such as an emergency alert system (in the future) or activates a remote visible/audible alarm FIG. 2 if it falls below or above the preset safe range. The safety temperature sensing alarm is a device used on a carrier or confined space that needs to be monitored, to alert anybody around that the temperature is too hot or too cold for the child's/person's/pet's/plant's safety. It works by detecting the temperature and sending a sound/visual alarm to alert anybody around that something is wrong. The temperature set points can be easily adjusted.

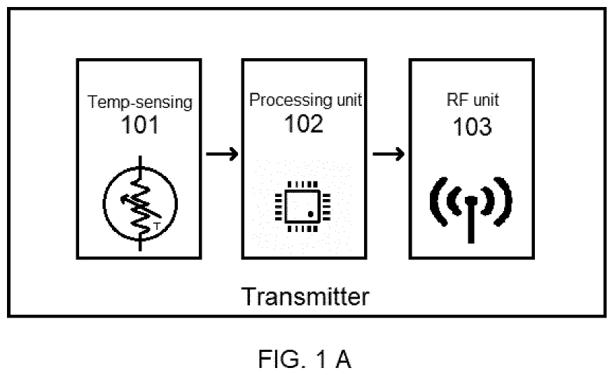

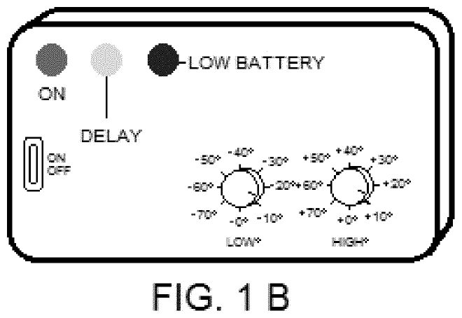

The invention is made of 2 components, a base transmitter FIG. 1 and a remote receiver FIG. 2. Soon to be adaptable to an emergency alert system.

The base's components are a time delay circuit board (which will be optional); it will help with any extreme temperatures that can occur initially in any place, a temperature sensing unit (which can have optional adjustable low and high temperature-sensing), a low-battery indicator with an LED, a battery, an on/off switch, a processing unit, and an RF remote transmitter. The two adjustable potentiometers are preset to a certain resistance. Any more power over that point will set the buzzer on and/or that will alert anybody around that something is wrong and needs intervention.

The remote's components are an on/off switch, am RF receiver, a low battery indicator, a battery, an LED, and a buzzer.

I claim:

1. The first to use a wireless/RF signal for electric actuation of an alarm that has a thermally-operated switch to alert a remote device and/or emergency alert system that temperatures changed.
The first to use a wired/wireless or RF signal thermally sensing alarm with multiple user defined temperature set points (low and high).
The first overall usage of RF signal (wireless alarm system, or an emergency alert system) that is activated by the change in user defined set point temperatures.
The first thermal wirelessly actuated safety alarm system that uses 9 v battery for both remote and base.
The first to use a low voltage warning circuit in a thermal wirelessly actuated safety alarm system remote and base.
The first thermal wirelessly actuated safety alarm system that is made of two components base and remote.
The first to implement an on-off safety belt switch for a thermal wirelessly actuated safety alarm system.
Any device or devices wired or wireless that uses a thermal wirelessly actuated safety alarm system that it is used to alarm in any way as a buzzer or a visual light or by sending any wired or wireless signal to a second device or service system device or devices to alert anyone in case of sensing that the temperature dropped too low or is too high.
